(19) United States
(12) Patent Application Publication
(10) Pub. No.: US 2009/0177568 A1
(43) Pub. Date: Jul. 9, 2009

(54) System And Method For Conducting Account Requests Over A Network Using Natural Language

(76) Inventors: Michael D. Hodges, Omaha, NE (US); Robert S. Beck, JR., La Vista, NE (US)

Correspondence Address: GIBBONS P.C., ONE GATEWAY CENTER, NEWARK, NJ, 07102, US

(21) Appl. No.: 11/971,691

(22) Filed: Jan. 9, 2008

(51) Int. Cl. G06Q 40/00

(52) U.S. Cl. 705/35

(57) ABSTRACT

The invention is directed to a system and method for conducting account requests with a financial institution accessible with a client device over a network. An account is established with the financial institution and a user can access the account via the client device. The client device has a user interface that includes a natural language input. A request is input via the natural language input. The inputting step causes network components (e.g., server 42 and one or more software modules 50) to determine whether the request can be granted. Information respecting the request is transmitted to the user interface. The information includes an indication of whether the request can be granted. The inputting step can cause the network components to query a search engine. In this case the search engine returns search results respecting the request. The request can be generally selected from the group including: a request for historical account information, a request for market price data, a request for analysis information, a request for a purchase of a security, a request for a sale of a security, or a request for status information. The received information respecting the request can include a plurality of transaction choices, ones of which when selected cause the network components to execute steps in furtherance of the request. The received information respecting the request can also include a request for confirmation of the request. The system can access account information associated with the account and use at least a portion of the account information in connection with processing the request.

### FIELD OF THE INVENTION

The present invention generally relates to systems and methods for conducting account requests or transactions over a network. More particularly, the present invention relates to systems and methods for conducting account requests or transactions using natural language queries for example in connection with on-line securities trading platforms.

### BACKGROUND OF THE INVENTION

Various systems and methods have addressed problems associated with securities trading platforms. Typical online trading platforms provide a multi-user environment for the processing of securities related transactions. Each of these systems and methods has advantages and disadvantages. For example, U.S. Pat. No. 6,408,282 entitled “System and method for conducting securities transactions over a computer network” discloses the trading of securities over the Internet both on national exchanges and outside the national exchanges. The system supports a GUI interface and a continuous display of real-time stock quotes on the user's computer screen.

U.S. Pat. No. 7,020,611 entitled “User Interface Selectable Real Time Information Delivery System and Method” discloses a system that enables users to retrieve information from different types of user interfaces. The information is originally saved in a format suitable for a particular type of user interface, such as video displays. The information is then converted to a different format suitable for a different type of user interface, such as an audio speaker.

It would be desirable to create a system and method that is easy and intuitive to use for any level of online investor. It would also be desirable to create a process by which users could find information about securities, buy or sell securities, and project future growth among other things. Such improvements would take much of the complexity out of online trading and truly open up on-line trading to any level of user.

### BRIEF SUMMARY OF THE INVENTION

The invention is directed to a system and method for conducting account requests with a financial institution accessible with a client device over a network. An account is established with the financial institution and a user can access the account via the client device. The client device has a user interface that includes a natural language input. A request is input via the natural language input. The inputting step causes network components (e.g., server 42 and one or more software modules 50) to determine whether the request can be granted. Information respecting the request is transmitted to the user interface. The information includes an indication of whether the request can be granted.

The inputting step can cause the network components to query a search engine. In this case the search engine returns search results respecting the request. The request can be generally selected from the group including: a request for historical account information, a request for market price data, a request for analysis information, a request for a purchase of a security, a request for a sale of a security, or a request for status information.

The received information respecting the request can include a plurality of transaction choices, ones of which when selected cause the network components to execute steps in furtherance of the request. The received information respecting the request can also include a request for confirmation of the request. The system can access account information associated with the account and use at least a portion of the account information in connection with processing the request. The system can optionally include a speech recognizer and can receive audio based requests.

### BRIEF DESCRIPTION OF THE DRAWINGS

For a better understanding of the present invention, reference is made to the following description and accompanying drawings, while the scope of the invention is set forth in the appended claims:

FIG. 1 shows an exemplary system diagram in accordance with the invention;

FIGS. 2a-2c show exemplary menu interfaces as are known in the art;

FIG. 3 shows an exemplary stock buy screen as is known in the art;

FIGS. 4a and 4b show a command line interface for user initiated transactions as is known in the art;

FIG. 5 shows a natural language query interface in accordance with the invention;

FIG. 6 is a high level flow chart showing basic natural language processing in accordance with the invention;

FIG. 7 is a high level flow chart showing additional natural language processing in accordance with the invention;

FIG. 8 shows an exemplary confirmation screen for an exemplary natural language “Buy” request in accordance with the invention;

FIG. 9 shows an exemplary confirmation screen for an exemplary natural language “Sell” request in accordance with the invention;

FIG. 10 shows an exemplary results screen for a historical stock price quote in accordance with the invention;

FIG. 11 shows an exemplary results screen for a current stock price quote in accordance with the invention;

FIG. 12 shows an exemplary results screen for an account projection request in accordance with the invention;

FIG. 13 shows another exemplary results screen for an account projection request in accordance with the invention; and

FIG. 14 shows exemplary web search results in accordance with the invention.

### DETAILED DESCRIPTION OF THE INVENTION

### I. System Overview

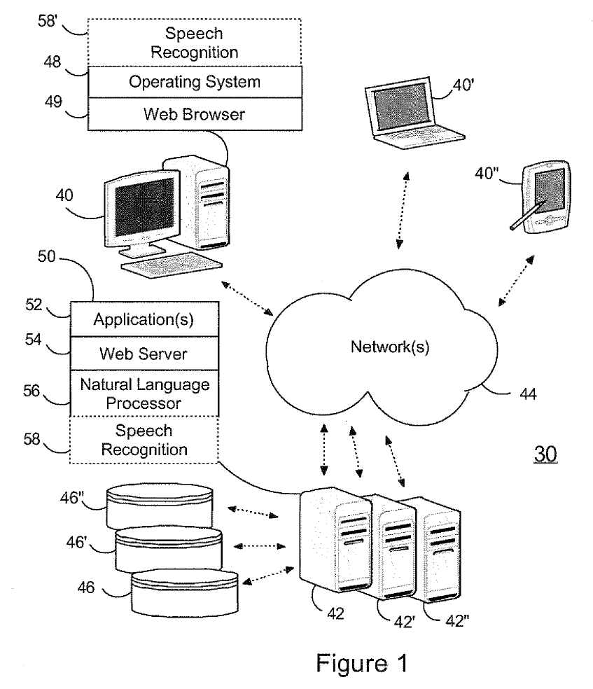

FIG. 1 shows an exemplary system diagram in accordance with the invention. The system 30 includes one or more client devices 40, 40′, 40″ connected to one or more servers 42, 42′, 42″ via a network 44 (e.g., intranet, Internet or the like). In this example, the server(s) are generally associated with a plurality of software modules 50 including one or more applications 52 (e.g., implementing an online trading platform), a web server 54 and a natural language processor 56 as discussed in more detail below The system can be configured to accept text based or audio based natural language requests. For example, the system can optionally include a speech recognition module 58, 58′. The speech recognition module can be installed on the client device via a variety of methods including a plug-in, browser helper object or the like. It is understood portions of software module 58, 58′ may be executed by a processor contained in a client device, system servers or combination thereof. Acceptable speech recognition software can be obtained from a variety of commercial sources including Dragon naturally speaking—Nuance Burlington, Mass., www.nuance.com as well as others. In general, the speech recognition module accepts audio input an produces a textual output. The text output is then suitable for recognition by the natural language processor 56. It is understood that client devices 40, 40′, 40″ can be supplied with a microphone (not shown) for receiving audio input. In some cases, the speech recognition software can be supplied as part of the operating system 48 (for example Microsoft Windows Vista speech recognition).

The server(s) can also access and/or maintain account information (e.g., stored in database 46, 46′, and 46″) for a plurality of users. The servers can also provide a user interface (e.g., via a web interface) so that a given user can log into the system, request information (e.g., historical or current security pricing . . . ), initiate a transaction (buy or sell a security, options . . . ) or the like. It is understood that a virtually unlimited number of users can be associated with the system.

It is also understood that the system may be implemented with a variety of security measures (not shown) to ensure system integrity. For example, the system may include various security mechanisms to ensure that the user is properly authorized to access the system including: passwords, digital certificates, encryption, biometrics or the like as is well known in the art. In cases where speech recognition is utilized, the user's account information can include one or more biometric templates (or voice prints) associated with the user. The system can then perform speaker identification and/or voice authentication prior to taking any further action.

FIG. 1 generally shows the data communications paths between the client devices, network and servers as dashed lines. It is understood that communications between these devices can be achieved via a variety of conventional methods (e.g., wired, wireless and the like). It is also understood that a variety of data networks using various network protocols are suitable for use in accordance with the invention (e.g., TCP/IP, HTTP . . . ). It is also understood that communications via the Internet often traverse a series of intermediate network nodes prior to reaching the desired destination. The arrows shown in FIG. 1 do not suggest a direct physical connection between the users, networks and servers and encompass typical network and/or Internet communications (a connectionless, best-efforts packet-based system).

The server(s) can access real time and historic data sources as shown by database 46, 46′ 46″. Data sources can include user account data, data relating to one or more securities, as well as other on-line information (e.g., accessed via the Internet). The term “security” as used herein is defined in 15 U.S.C. §78c(a)(10) and generally includes “any note, stock, treasury stock, security future, bond, debenture, certificate of interest or participation in any profit-sharing agreement or in any oil, gas, or other mineral royalty or lease, any collateral-trust certificate, preorganization certificate or subscription, transferable share, investment contract, voting-trust certificate, certificate of deposit for a security, any put, call, straddle, option . . . ”.

In this example, the client device 30 (typical PC and web browser) is operable to access the Internet World Wide Web. The client device 30 generally has an associated operating system 48 such as Microsoft Windows or Linux and includes a typical Web Browser 49 such as Microsoft Internet Explorer or the like. The hardware and software configuration of client devices for Internet access is routine and generally known to those skilled in the art.

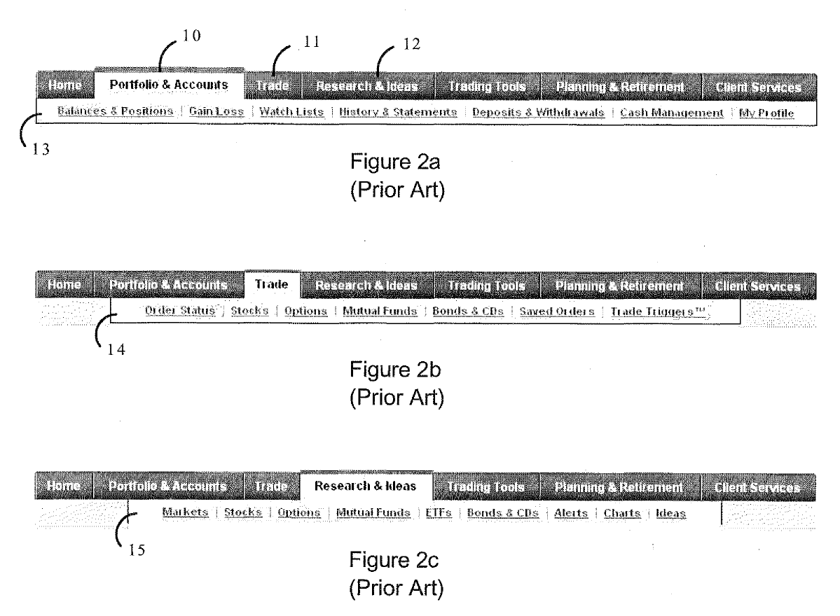

In the context of securities trading, it is generally known to provide a standard menu based user interface. For example, FIGS. 2a-2c show a typical menu based user interface. In this example, the menu includes a plurality of main topics some of which are denoted by reference numbers 10, 11, 12 (e.g., Portfolio & Accounts, Trade, Research & Ideas, Trading Tools . . . ) each associated with plurality of sub topics. FIG. 2a generally shows the sub topics 13 associated with a given user's portfolio and account. FIG. 2b generally shows the sub topics 14 associated with user initiated trades. FIG. 2c generally shows the sub topics 15 associated with user initiated research requests. In operation, the user simply selects or clicks on the desired main topic and then sub topic to obtain information, initiate a request, transaction or the like. It is understood that it may be necessary to traverse a plurality of nested sub topics before a given request or transaction can be initiated.

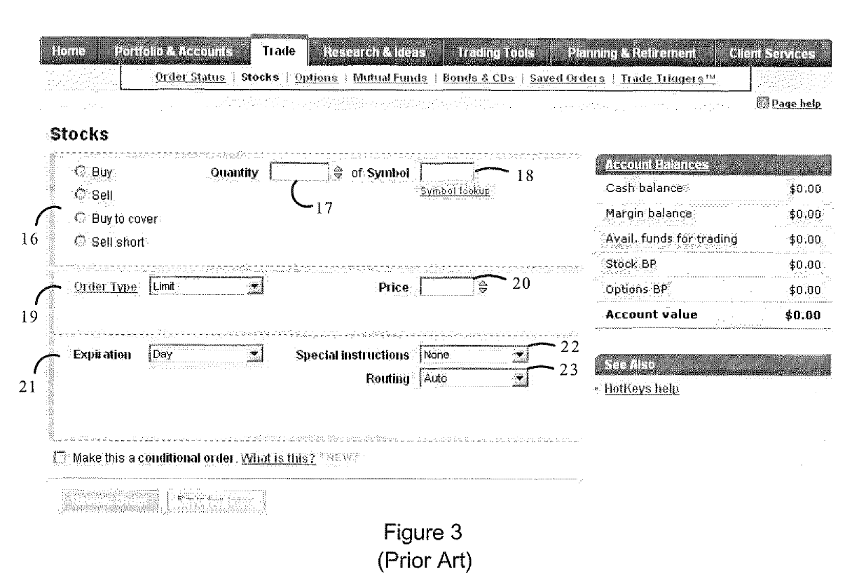

FIG. 3 shows an exemplary stock buy screen as is known in the art. In this example, the user selected the “Trade” main topic and the “Stocks” sub topic. The user is presented with a plurality data entry fields so that they can initiate an order. Each of the required data entry fields is selected in order to input the appropriate transaction type 16 (e.g., buy, sell, buy to cover, sell short), quantity 17, symbol 18, order type 19 (e.g., limit, market, stop market, stop limit, trailing stop %, trailing stop $), price 20, expiration 21, special instructions 22, routing 23 and the like. Once all of the required fields are populated, the system will allow the user to review the order and then place the order.

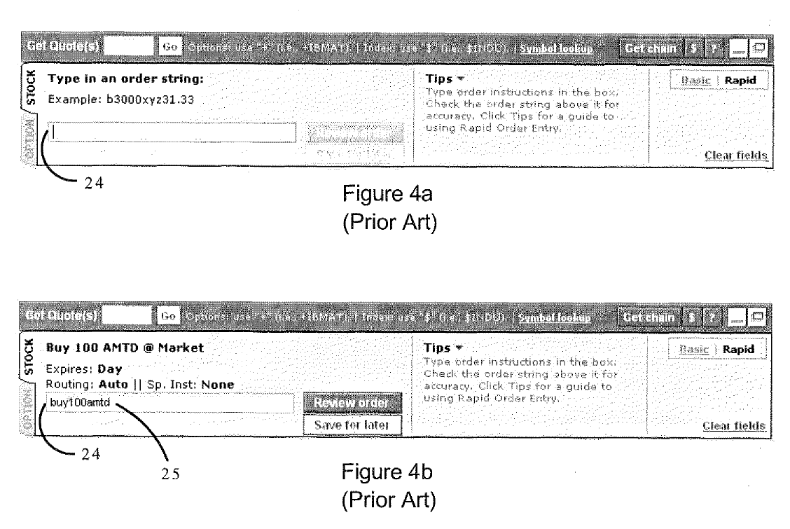

FIGS. 4a-4c show a command line interface 24 for user initiated transactions as is known in the art. In this example the user can buy, sell, buy to cover (bc), or sell short (ss) by inputting an order string 25 in a specific format In this example, the user wishes to purchase 100 shares of Ameritrade stock at market price. Accordingly, the user inputs the string “buy100amtd”. In the event the user needs additional information, they utilize the menu system and navigate to another screen to request such information. Similarly, if the user wishes to initiate another type of transaction (e.g., mutual funds, options, bonds & CDs . . . ) they again utilize the menu system and navigate to another screen to initiate such transactions.

The invention is accessed via a natural language interface that is integrated into an online trading platform. The natural language interface allows for an input process that is easy and intuitive to use for any level of online investor. Creating a process by which users could find information about securities, buy or sell securities, and project future growth would be an invaluable tool. As such, the invention takes much of the complexity out of online trading and truly opens it up to any level of user.

The invention provides the ability to access the account information of the user initiating the transaction and use that information to narrow the search and return better results. This “tagging” of information assists in the returning of good results in a timely manner. The invention can also be used to either search just the website associated with the on-line trading system or do a broader search on the World Wide Web. If the query is based strictly on the trading system website, the invention uses the individual's account information and history along with whatever stock information is present on the website's database to return the best match. If the query is based strictly on the World Wide Web, the invention will return the best match from information pulled therein. A technical effect of the invention is to provide an improved user interface enabling users to access a plurality of functions from a single input screen. Another technical effect of the invention is to provide an improved user interface that simplifies the input process.

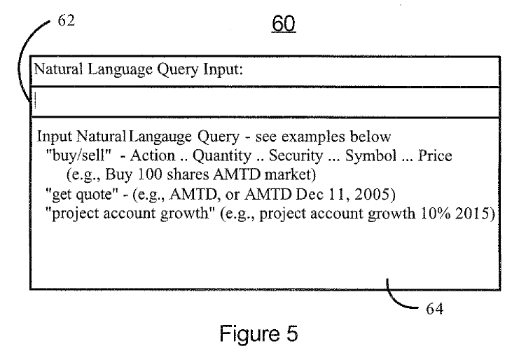

FIG. 5 shows a natural language interface 60 in accordance with the invention. In this example, the natural language interface includes an input line 62 and a message portion 64. The input line is generally configured to receive alpha numeric input from a user in natural language. The message portion can generally provide tips, examples and/or messages to the user to assist the user in formulating a natural language input. In general, the user can utilize the natural language interface to initiate a buy/sell request or transaction, initiate get quote request, initiate a project account growth request or request other information.

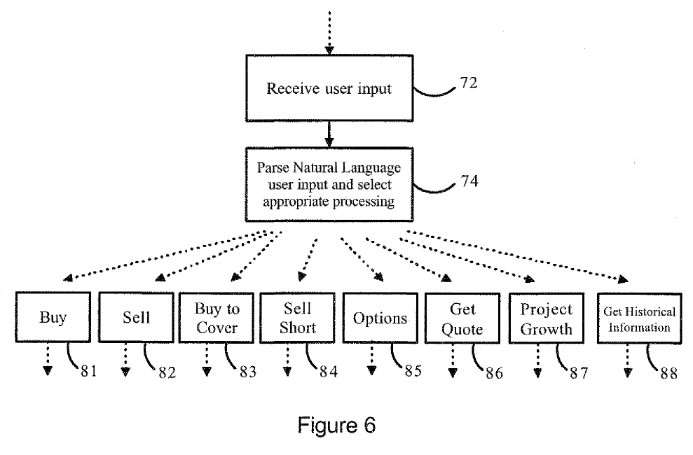

FIG. 6 is a high level flow chart showing basic natural language processing in accordance with the invention. It is understood that the flowcharts contained herein are illustrative only and that other program entry and exit points, time out functions, error checking routines and the like (not shown) would normally be implemented in typical system software. It is also understood that the system software can be implemented to run continuously. Accordingly any beginning and ending blocks are intended to indicate logical beginning and ending points of a portion of code that can be integrated into a main program and called as needed to support continuous system operation. Implementation of these aspects of the invention is readily apparent and well within the grasp of those skilled in the art based on the disclosure herein

The system generally waits for user input as shown by block 72. Upon receiving user input, the system parses the user input as shown by block 74. The system than makes a preliminary determination as to the general type of user request. The system then executes the applicable code segment or module to carry out the user request. For example the user may input a request in one of the following general categories: buy 81, sell 82, buy to cover 83, sell short 84, options 85, get quote 86, project growth 87, get historical information 88, search the World Wide Web and the like. Each of these requests or transactions are discussed in more detail below.

### II. Natural Language Processing—Buy/Sell

The format for a natural language input string or query will generally include a plurality of phrases or tokens (separated by spaces, commas or the like). In the case of a Buy/Sell request, the format is generally as follows: Action (e.g., transaction type) . . . Quantity . . . Security . . . Symbol . . . Order Type . . . Price. The input string is not required to be in a particular format or sequence. It is also understood that a subset of tokens may be sufficient to identify certain requests or transactions. For a typical buy or sell transaction “action” generally includes one of the following: Buy, Sell, Buy to Cover, Sell Short. The “Quantity” portion of the query will generally be a numeric input. The “Security” portion of the query generally identifies the type of security at issue (e.g., shares, options . . . ). The “Symbol” portion of the query generally identifies the security at issue (e.g., security name, security symbol). The order type is typically an alphanumeric string (e.g., limit, market, stop market, stop limit, trailing stop %, trailing stop $). The “Price” portion of the query generally is an alphanumeric string.

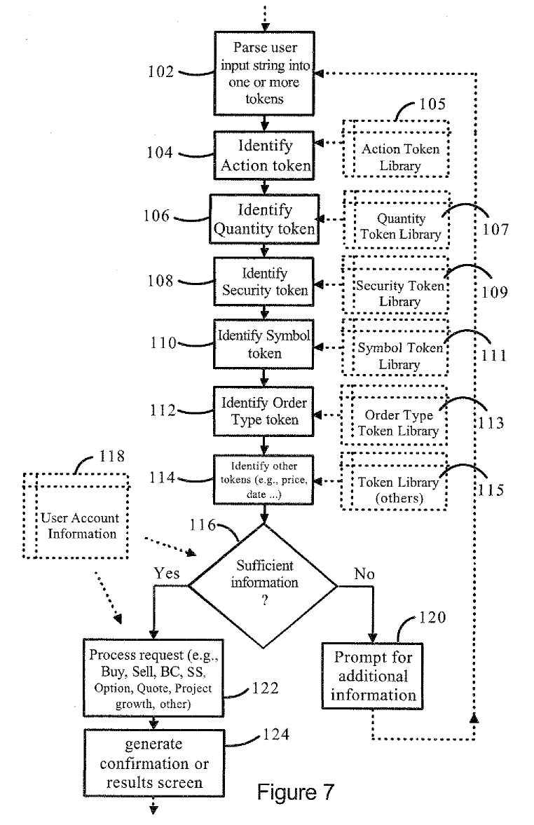

Assume for example, the user inputs the following string: Buy 100 shares AMTD market. FIG. 7 shows a high level flow chart with additional natural language processing details in accordance with the invention. As discussed above, the system parses the input string into one or more tokens as shown by block 102. In each of the following blocks 104, 106, 108, 110 112 and 114, the system attempts to match the token to a particular category (e.g., Action, Quantity, Security, Symbol, Order Type, Price . . . ). Blocks 104, 106, 108, 110, 112 and 114 are shown as individual blocks for purposes of clarity. It is understood that the system software pertaining to FIG. 7 may be implemented as an iterative, tree structured, or other process.

In a typical implementation, the system may maintain one or more libraries of acceptable tokens in each category (see e.g., blocks 105, 107, 109, 111, 113, 115). For example the Action token library may include the following tokens: Buy, Sell, Buy to Cover, Sell Short, Quote, Project Account Growth, Search and the like. The Quantity token library may include alphabetic representations of certain numbers (e.g., one, hundred, thousand . . . ). The Security token library may include the following tokens: Share, Stock, Bond and the like. The Order Type token library may include the following tokens: Limit, Market, Stop Market, Stop Limit, Trailing Stop %, Trailing Stop $ and the like. The “Other” token library may include other token types that do not fit into any of the categories set out above. The term library as recited herein is used in its general sense (e.g., a collection of information) and does not assume a particular format or structure. It is understood that libraries 105, 107, 109, 111, 113, 115 can be stored locally, remotely or a combination thereof.

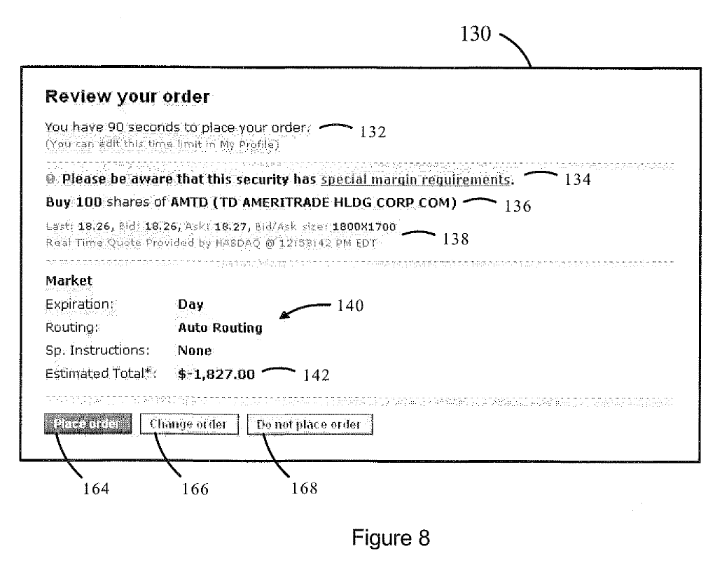

Once the input string is parsed, the system will identify any Action tokens (in this example “Buy”) as shown by block 104. Any quantity tokens are identified at block 106 (in this example “100”). Any security tokens are identified at block 108 (in this example “shares”). Any symbol tokens are identified at block 110 (in this example “AMTD”). Any order type tokens are identified at block 112 (in this example “market”). Any other tokens are identified at block 114. Control is passed to block 116 where the system determines whether sufficient information exists to process the request. The system can also access the users account information to assist in interpreting the request as shown by block 118 (discussed in more detail below). In this example, the user has input a string that contains sufficient information to initiate a buy transaction so control is passed to block 122. The system then generates a confirmation screen as depicted by block 124. The user is then prompted to confirm that they wish to execute the trade. FIG. 8 generally shows an exemplary confirmation screen 130 in accordance with the current example. The confirmation screen includes i) a time limit prompt 132, ii) a special requirements prompt 134 (if any), iii) a trade confirmation prompt 136, iv) a security pricing information prompt 138, v) other transaction details 140 (e.g., order type, expiration, routing, special instructions . . . ), and vi) an estimated total 142. The user can place the order by selecting or clicking on the “Place Order” button 164. In the alternative, the user can change or cancel the order by clicking on buttons 166, 168 respectively.

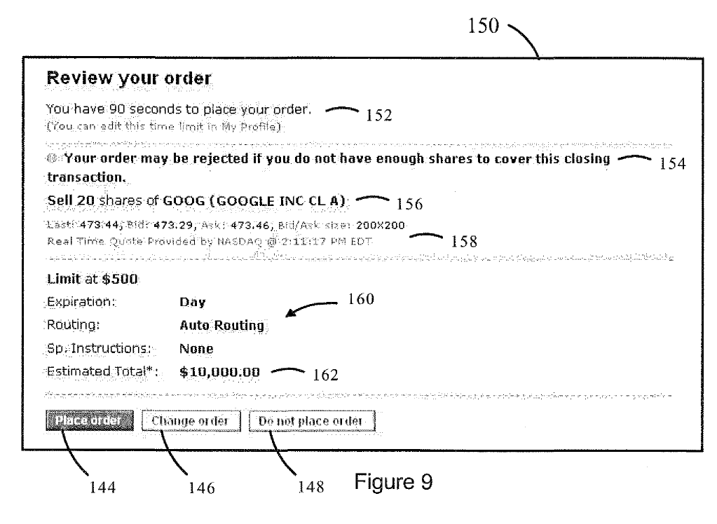

Assume for example, the user inputs the following string: Sell 20 shares Google limit $500. Referring again to FIG. 7, the system will first parse the input string into one or more tokens as shown by block 102. The system will then identify any Action tokens (in this example “Sell”) as shown by block 104. Any quantity tokens are identified at block 106 (in this example “20”). Any security tokens are identified at block 108 (in this example “shares”). Any symbol tokens are identified at block 110 (in this example “Google”). Since the user input the company name and not the stock symbol, the system will automatically lookup the symbol associated with the company name. In the event the system could not identify an exact match the system can select the closest match. In this example, the system identifies the GOOG symbol. Any order type tokens are identified at block 112 (in this example “limit”). Any other tokens are identified at block 114 (in this example price=“$500”). Control is passed to block 116 where the system determines whether sufficient information exists to process the request. The system can also access the users account information to assist in interpreting the request as shown by block 118 (discussed in more detail below). In this example, the user has input a string that contains sufficient information to initiate a sell transaction so control is passed to block 122. The system then generates a confirmation screen as depicted by block 124. The user is then prompted to confirm that they wish to execute the trade FIG. 9 generally shows an exemplary confirmation screen 150 in accordance with the current example. The confirmation screen includes i) a time limit prompt 152, ii) a special requirements prompt 154 (e.g., the user must own enough shares to cover the transaction), iii) a trade confirmation prompt 156, iv) a security pricing information prompt 158, v) other transaction details 160 (e.g., order type, expiration, routing, special instructions . . . ) and vi) an estimated total 162. The user can place the order by selecting or clicking on the “Place Order” button 164. In the alternative, the user can change or cancel the order by clicking on buttons 166, 168 respectively. It is readily apparent based on the foregoing two examples how a person of ordinary skill in the art would implement other variations of buy and sell transactions in accordance with the invention.

### III. Natural Language Processing—Quote

The format for a natural language quote request is generally as follows: Action (optional) . . . Symbol . . . Date (optional). The input string is not required to be in a particular format or sequence. It is also understood that a subset of tokens may be sufficient to identify certain transactions. For a typical quote request “Symbol” generally identifies the security at issue (e.g., security name, security symbol). The “Date” portion of the query (optional) generally can be included so that the results indicate the historical pricing of the security at issue. In the case of a quote request, the user can also include an optional “Action” portion of the query (for example “quote”).

Assume for example, the user inputs the following string: AMTD Dec. 12, 2005. Referring to FIG. 7, the system will first parse the input string into one or more tokens as shown by block 102. The system will then identify any Action tokens (in this example no action tokens are present) as shown by block 104. Any quantity tokens are identified at block 106 (in this example no quantity tokens are present). Any security tokens are identified at block 108 (in this example no security tokens are present). Any symbol tokens are identified at block 110 (in this example “AMTD”). Any order type tokens are identified at block 112 (in this example no order type tokens are present). Any other tokens are identified at block 114 (in this example date=“Dec. 12, 2005”).

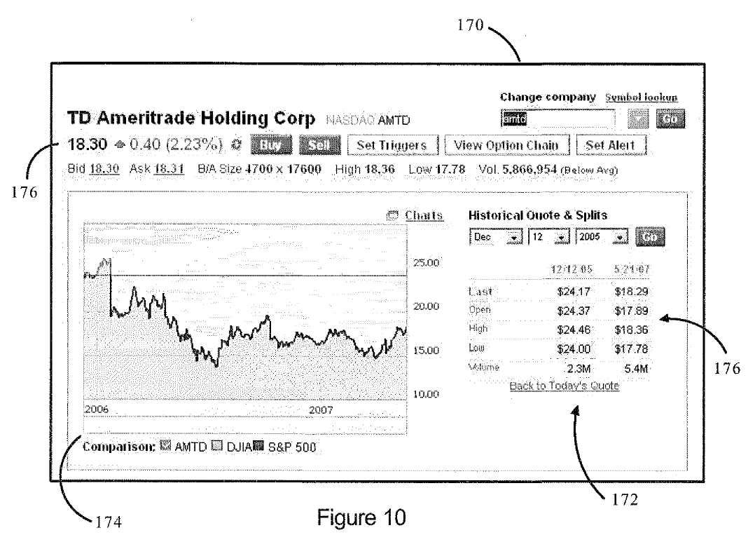

Control is passed to block 116 where the system determines whether sufficient information exists to process the request. The system can also access the users account information to assist in interpreting the request as shown by block 118 (discussed in more detail below). In this example, the user has input a string that contains sufficient information to request a quote of AMTD on Dec. 11, 2005. The system then generates a results screen as depicted by block 124. FIG. 10 generally shows an exemplary results screen 170 in accordance with the current example. The results screen generally includes i) historical pricing information 172, ii) a chart 174, and ii) current pricing information 176.

Assume for example, the user inputs the following string: Quote AMTD. Referring to FIG. 7, the system will first parse the input string into one or more tokens as shown by block 102. The system will then identify any Action tokens (in this example “Quote”) as shown by block 104. Any quantity tokens are identified at block 106 (in this example no quantity tokens are present). Any security tokens are identified at block 108 (in this example no security tokens are present). Any symbol tokens are identified at block 110 (in this example “AMTD”). Any order type tokens are identified at block 112 (in this example no order type tokens are present). Any other tokens are identified at block 114.

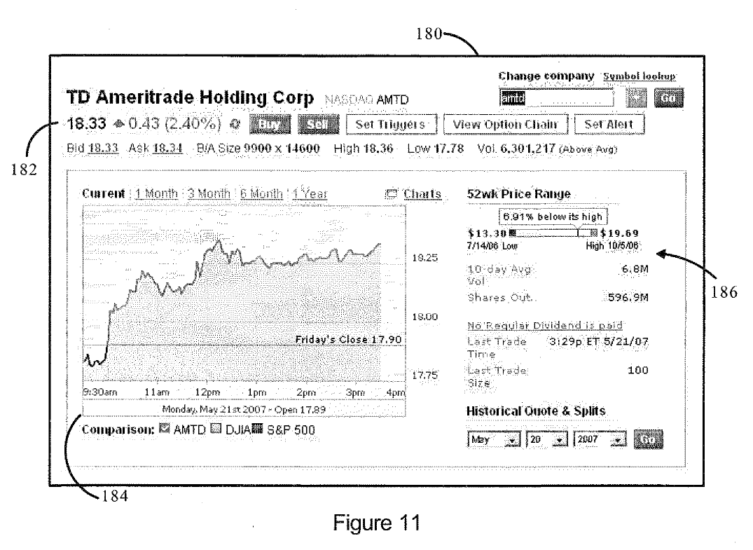

Control is passed to block 116 where the system determines whether sufficient information exists to process the request. The system can also access the users account information to assist in interpreting the request as shown by block 118 (discussed in more detail below). In this example, the user has input a string that contains sufficient information to request a current quote of the pricing of AMTD. The system then generates a results screen as depicted by block 124. FIG. 11 generally shows an exemplary results screen 180 in accordance with the current example. The results screen generally includes i) current pricing information 182, and ii) a chart 184. It is readily apparent based on the foregoing examples how a person of ordinary skill in the art would implement other variations of quote transactions in accordance with the invention.

### IV. Natural Language Processing—Project Account Growth

The foregoing examples provide user access to features that have corresponding menu entries in an existing on-line trading platform. The invention is advantageous in that the user can access a variety of functions from a single interface, without the need to traverse various menu levels and the like However, the invention can also provide access to features that do not have corresponding menu entries in an existing on-line trading platform. This allows for the introduction of new features without modifying the existing menu structure and can speed feature introduction.

For example, the invention can provide access to research or analysis tools. One useful tool provides projected account growth based on certain assumptions about future returns. The format for such a natural language request is generally as follows: Action . . . Yield . . . Years/Date. The input string is not required to be in a particular format or sequence. It is also understood that a subset of tokens may be sufficient to identify certain transactions. For a typical account projection request the “Action” token is generally: Project account growth. The “Yield” portion of the request will generally be a numeric input such as (10%) or an alphabetic input to identify a particular index to be used in the projection (e.g., Dow). The “Years/Date” portion of the request is generally a numeric input and identifies the number of years to carry out the projection (e.g., 10). If just one year is specified, the system will carry out the projection from the current date through the year specified.

Assume for example, the user inputs the following string: Project account growth 10% 2015. Referring to FIG. 7, the system will first parse the input string into one or more tokens as shown by block 102. The system will then identify any Action tokens (in this example “: Project account growth”) as shown by block 104. Any quantity tokens are identified at block 106 (in this example no quantity tokens are present). Any security tokens are identified at block 108 (in this example no security tokens are present). Any symbol tokens are identified at block 110 (in this example no symbol tokens are present). Any order type tokens are identified at block 112 (in this example no order type tokens are present). Any other tokens are identified at block 114 (in this case Yield=10% and Date=2015).

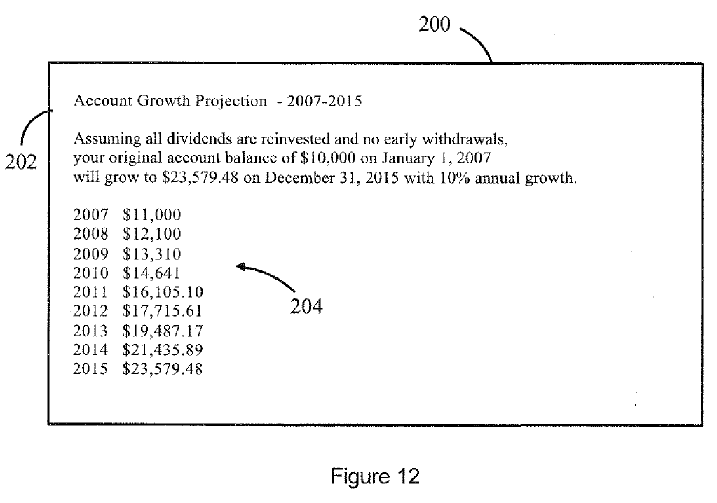

Control is passed to block 116 where the system determines whether sufficient information exists to process the request. The system can also access the users account information to assist in interpreting the request as shown by block 118. In this example, the user has input a string that contains sufficient information to request an account growth projection (for current securities owned by the user) with a 10% yield from the current date through the last day of 2015. The system utilizes the users account information and identifies the user's account balance. Assume for this example, the users account balance on Jan. 1, 2007=$10,000. The system then carries out one or more future value calculations. For example, the system can utilize the following formula: fv=p(1+r)ⁿ, where: fv=future value, p=starting principal, r=rate and n=number of years. The system then generates a results screen as depicted by block 124. FIG. 12 generally shows an exemplary results screen 200 in accordance with the current example. The results screen generally includes i) a summary of the projection and any assumptions 202 and ii) a yearly projection throughout the period of interest 204.

Assume for example, the user inputs the following string: Compare the DOW to the Russell 2000 from 2004-2006. Referring to FIG. 7, the system will first parse the input string into one or more tokens as shown by block 102. The system will then identify any Action tokens (in this example “Compare”) as shown by block 104. Any quantity tokens are identified at block 106 (in this example no quantity tokens are present). Any security tokens are identified at block 108 (in this example “Dow” and “Russell 2000”). Any symbol tokens are identified at block 110 (in this example no symbol tokens are present). Any order type tokens are identified at block 112 (in this example no order type tokens are present). Any other tokens are identified at block 114 (in this case Date range=2004-2006).

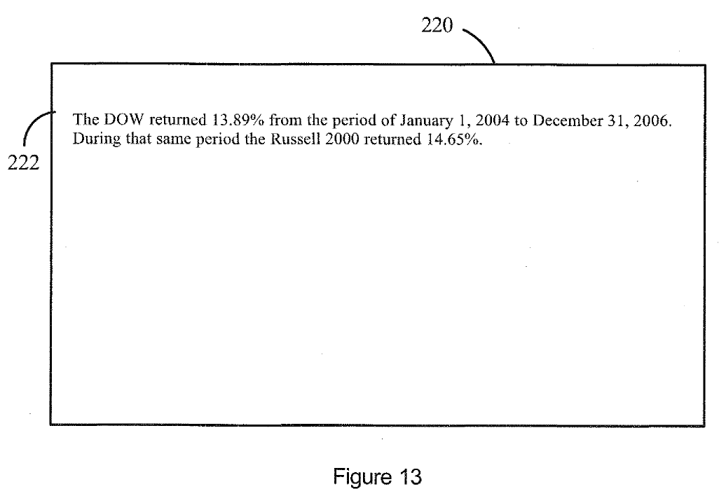

Control is passed to block 116 where the system determines whether sufficient information exists to process the request. The system can also access the users account information to assist in interpreting the request as shown by block 118. In this example, the user has input a string that contains sufficient information to request a comparison of the DOW and Russell 2000 indexes from 2004 though 2006. The system generates a results screen as depicted by block 124. FIG. 13 generally shows an exemplary results screen 220 in accordance with the current example. The results screen generally includes the results comparing the two indexes 222.

### V. Natural Language Processing—Other Search Requests

The foregoing examples generally provide a user with information derived primarily from the on-line trading system's database 46, 46′ and 46″. However, the system can also initiate a web search and return the search results to the user. For example, if the system is unable to locate an action token or otherwise discern a specific user request, the system can initiate a web search and return the results to the user.

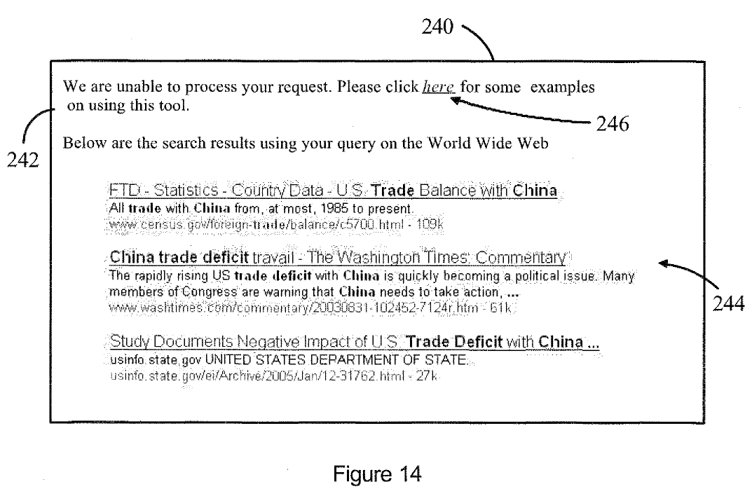

Assume for example, the user inputs the following string: China trade deficit. Referring to FIG. 7, the system will first parse the input string into one or more tokens as shown by block 102. The system will be unable to locate tokens in any specific category. Control is passed to block 116 where the system determines whether sufficient information exists to process the request. In this example, the user has input a string that lacks sufficient information to request a specific action or system function. By default the system can then initiate a web search. The system generates a results screen as depicted by block 124. FIG. 14 generally shows an exemplary results screen 240 in accordance with the current example. The results screen generally includes i) an introductory message 242, and ii) web search results 244 with links to applicable web sites that may contain information that is relevant to the user. In this particular example, the introductory message also includes an HTML link 246 to examples (not shown) to assist the user with operation of the system.

In the foregoing examples, the results screens 130, 150, 170, 180, 200, 220 and 240 are shown as separate screens. It is understood that the results can be integrated with or otherwise included in the natural language interface 60 (e.g., within message portion 64). It is also understood that a variety of results, with varying levels of detail, can be provided without departing from the scope of the invention Although the examples above show only text based input, the system can be configured with a speech recognition module and can accept audio based natural language requests without departing from the scope of the invention. While the foregoing description and drawings represent the preferred embodiments of the present invention, it will be understood that various changes and modifications may be made without departing from the scope of the present invention.

What is claimed is:

1. A method for conducting account requests with a financial institution accessible with a client device over a network, the method comprising:
establishing an account with the financial institution;
accessing the account via the client device, the client device having a user interface, the interface including a natural language input;
inputting a request via the natural language input; the inputting step causing network components to determine whether the request can be granted; and
receiving via the interface information respecting the request, the information including an indication of whether the request can be granted.

2. The method of claim 1 wherein the inputting step causes the network components to query a search engine, the search engine returning search results respecting the request.

3. The method of claim 1 wherein the request comprises one selected from the group including a request for historical account information, a request for market price data, a request for analysis information, a request for a purchase of a security, a request for a sale of a security, or a request for status information.

4. The method of claim 1 wherein the received information respecting the request includes a plurality of transaction choices, ones of which when selected cause the network components to execute steps in furtherance of the request.

5. The method of claim 1 wherein the received information respecting the request includes a request for confirmation of the request.

6. The method of claim 1 comprising accessing account information associated with the account and using at least a portion of the account information in connection with processing the request.

7. The method of claim 1 wherein the request is a text or audio input.

8. A method for conducting account requests with a financial institution accessible with a client device over a network, the method comprising:
establishing an account with the financial institution;
accessing the account via the client device, the client device having a user interface, the interface including a natural language input;
inputting a request via the natural language input parsing the request into tokens and identifying one of a plurality of functions associated with the request thereby determining whether the request can be granted; and
performing at least one function associated with the request and returning via the interface information pertaining to the request, the information including an indication of whether the request can be granted.

9. The method of claim 8 wherein the inputting step causes the network components to query a search engine, the search engine returning search results respecting the request.

10. The method of claim 8 wherein the inputting step causes the network components to initiate one of a buy, sell, buy to cover, sell short, quote, project account growth, and web search request.

11. The method of claim 8 wherein the received information respecting the request includes a plurality of transaction choices, ones of which when selected cause the network components to execute steps in furtherance of the request.

12. The method of claim 8 wherein the received information respecting the request includes a request for confirmation of a transaction associated with the request.

13. The method of claim 8 comprising accessing account information associated with the account and using at least a portion of the account information in connection with processing the request.

14. The method of claim 7 wherein the request is a text or audio input.

15. A method for processing account requests with a financial institution accessible with a client device via a network, the method comprising:
maintaining a plurality of user accounts;
providing to the client device a network interface including a natural language input;
receiving from the network interface a natural language request;
processing the natural language request and determining whether the request can be granted;
returning to the client device via the network interface information indicating whether the request can be granted.

16. The method of claim 15 further comprising the steps of:
maintaining predetermined sets of instructions which when executed in response to the request carry out an account transaction for the user account, the data including data identifying the predetermined sets of instructions; and
executing at least one predetermined set of instructions in response to the request.

17. The method of claim 15 wherein the request comprises one selected from the group including a request for historical account information, a request for market price data, a request for analysis information, a request for a purchase of a security, a request for a sale of a security, or a request for status information.

18. The method of claim 16 wherein the determining step includes identifying at least one predetermined set of instructions.

19. The method of claim 18, wherein the at least one predetermined set of instructions includes a plurality of predetermined sets of instructions, comprising the further step of returning to the user for selection via the network interface indications of the plurality of predetermined sets of instructions.

20. The method of claim 15 further comprising the steps of:
in response to the transaction request, creating at least one set of instructions which when executed carry out an account transaction for the user account; and
executing the at least one set of instructions.

21. The method of claim 15 wherein the request is a text or audio input.

22. A system for conducting account requests with a financial institution accessible with a client device over a network, the system comprising:
a server that receives a natural language request from the client device,
a natural language processor that parses the request into tokens and identifies one of a plurality of functions associated with the request thereby determining whether the request can be granted; and
at least one application that performs at least one function associated with the request and returns to the client device information pertaining to the request to the, wherein the information includes an indication of whether the request can be granted.

23. The system of claim 22 wherein receipt of the natural language request causes the system to query a search engine, the search engine returning search results respecting the request.

24. The system of claim 22 wherein receipt of the natural language request causes the system to initiate one of a buy, sell, buy to cover, sell short, quote, project account growth, and web search request.

25. The system of claim 22 wherein the natural language request includes a plurality of transaction choices, ones of which when selected cause the system to execute steps in furtherance of the transaction request.

26. The system of claim 22 wherein the received information respecting the transaction request includes a request for confirmation of a transaction associated with the request.

27. The system of claim 22 wherein the system maintains at least one account and the at least one application accesses account information associated with the account and uses at least a portion of the account information in connection with processing the request

28. The system of claim 22 comprising a speech recognizer that receives at least one audio based request.

29. A system for conducting account requests with a financial institution accessible with a client device over a network, the system comprising:
means for receiving a natural language request from the client device,
means for parsing the request into tokens and identifying one of a plurality of functions associated with the request thereby determining whether the request can be granted; and
means for performing at least one function associated with the request and returning to the client device information pertaining to the request to the, wherein the information includes an indication of whether the request can be granted.
